(19) United States
(12) Patent Application Publication
(10) Pub. No.: US 2008/0050550 A1
(43) Pub. Date: Feb. 28, 2008

(54) Contact and capacitive touch sensing controllers with electronic textiles and kits therefor

(76) Inventor: Margaret A. Orth, Seattle, WA (US)

Correspondence Address: LAW OFFICE OF POLLY L. OLIVER, 3134 Parkside Circle NE, Tacoma, WA, 98422, US

(21) Appl. No.: 11/895,846

(22) Filed: Aug. 27, 2007

Related U.S. Application Data
(60) Provisional application No. 60/844,493, filed on Sep. 13, 2006.
(60) Provisional application No. 60/840,756, filed on Aug. 28, 2006.

(51) Int. Cl. B32B 33/00

(52) U.S. Cl. 428/90

(57) ABSTRACT

A tufted controller using electronic textiles offers a unique way of controlling on/off and similar functions of electric and electronic devices. The uniquely soft and tactile tufted controllers offer relatively larger areas of more versatile contact over the prior art (i.e., flat, hard capacitive contact sensors). The tufted controllers may be constructed with yarn, string, thread, cordage or the like—even novelty yarns, like boucle- or eyelash type. Kits for building such controllers—especially for lamps and patches are popular craft projects.

### RELATED APPLICATIONS

The present application is related to and claims priority under 35 U.S.C. 119(e) from U.S. Provisional Application No. 60/844,493, entitled “Kits for Constructing Electronic Textile Devices with Contact and Capacitive Touch Sensing,” filed Sep. 13, 2006, and U.S. Provisional Application No. 60/840,756, entitled “Method for Contact and Capacitive Touch Sensing with Electronic Textile” filed Aug. 28, 2006, both of which are hereby incorporated by reference in its entirety.

### FIELD OF THE INVENTION

This invention pertains generally to controllers for electronic and electrical devices and more specifically to capacitive touch controllers having sensing electrodes that are made with tufted, lofted, piled, fuzzy, or other conductive yarn or fibers and which are useful in many different applications, e.g., toys, appliances, lamps, computer games, and medical devices.

### BACKGROUND OF THE FIELD

In known methods of capacitive touch—or contact—sensing, a flat, conductive textile or electrode (i.e., load plate) is attached to a capacitive sensing circuit. The textile is charged, and the change in charge is measured when the user's body touches the textile. Methods for making these electrodes include flat, woven, conductive fabrics and machine embroidery. All these methods create a flat, conductive, textile electrode, where the user's hand touches a single horizontal layer of conductive fibers.

While these methods provide a flexible, or bendable, sensing electrode (that can be integrated into clothing and other soft-goods), they do not provide a soft, or uniquely tactile, method for contact sensing. Moreover, these methods provide only a flat, single layer of conductive fibers which offers only a small area of contact and which requires Z-direction pressure (“direct pressure” as opposed to squeezing or brushing) on a load plate. Such Z-direction pressure is difficult to achieve in a stuffed toy or soft-good because there is nothing firm to press against. Lofted and piled sensors provide not only a larger area of contact and a unique tactile experience for the user, but also the ability for the user to make contact with the sensor in the x- and/or y-directions (where the finger or hand can touch the fiber in either or both directions simultaneously—which requires less pressure).

Flat sensors, because of their limited surface, can also become soiled and resist discharge, requiring more and more pressure to be exerted by the user to discharge the circuit. Over time, these sensors can feel hard.

The prior art U.S. Pat. No. 7,054,133 to M. Orth discloses a method for using electronic textiles in a very limited configuration—a generally spherical pom pom. Such a configuration also provides—as do other prior art—only a limited area of contact and cannot be integrated into the broader range of physical configurations for creating lofted and piled capacitive, contact sensors on the surface of, or integrated into, a textile.

### SUMMARY OF THE INVENTION

The present invention of the tufted controller solves the above-mentioned problems by providing capacitive, contact sensors with electronic textiles that are uniquely soft and tactile and offer relatively larger areas of more versatile contact. As more and more electronic devices are being integrated into toys and other soft and furry products, these soft tufted, fuzzy, piled, or lofted contact sensors according to this invention provide a pleasant and unique experience for the user when touching electronic devices—in contrast with hard buttons embedded inside a fur skin. These tufted controllers (which are called and described as “tufted” although they can be manufactured in many different ways, as will be discussed later) also provide a means for integrating the sensor directly and seamlessly into the textile, and/or products. For instance, by integrating lofted conductive yarn directly into fake fur, a fully integrated and seamless “area” of sensing can be created.

Integrating conductive yarns into a textile, in such a manner that provides an opportunity for the lofted yarns to be used as a sensor is novel and non-obvious. Using a variety of textile methods allows for many ways for lofted conductive fibers to be integrated into textiles and products.

These sensors also benefit disabled and handicapped people because they are soft and do not require the mechanical manipulation or Z-direction pressure (“direct pressure”) that a flat sensor with a single layer of accessible conductive fibers requires. Instead, the sensors may be incorporated in various configurations that may be squeezed, brushed, or pushed in any direction (x-, y-, or z- or a combination thereof to activate the associated electronic device.

The elevated pile construction of lofted and/or fuzzy sensors also provides technical and engineering advantages. Multiple elevated fibers provide users with more surface area to contact. More charged surface area on the fibers means that they are more easily discharged, less pressure is required, and less dirt builds up on the surface. Direct integration of lofted fibers into textiles allows any part of the toy or the textile to become a sensing surface. These textile processes also allow for the creation of sensor areas of any shape or design. For instance, a circle or square of conductive pile can be creating in weaving, knitting, hooking, pile-making, or other processes.

Creating fun and educational kits that allow the public to create their own e-textile capacitive touch sensors and devices that incorporate such sensors is also desirable and can be achieved with this invention. Currently, there is greater and greater interest in crafting and sewing and creating wearable fashions with integrated electronics. Such kits may include appropriate yarns, fibers, or other conductive materials—or combinations of conductive and-or non-conductive materials—that are soft and appealing, yet conductive enough to replace a load plate, i.e., provide the correct electrical and textile properties. Kits may also include instructions for fabricating these materials for electrical conductivity and connecting these elements to a sensing circuit thereby assembling the electronic touch controller.

### BRIEF DESCRIPTION OF THE DRAWINGS

FIG. 1 illustrates a preferred embodiment of the present invention of the tufted controller using lofted, looped, conductive fibers with non-conductive support material;

FIG. 1A is an alternate embodiment with looped, but then cut conductive fibers giving a different look and feel to the tufted controller;

FIG. 1B is a craft kit including conductive fibers and non-conductive support material;

FIG. 2 is an alternate embodiment using lofted, cut, conductive fibers with conductive support material;

FIG. 2A is an alternate embodiment with conductive fibers integrated into the support material in one direction, a common situation;

FIG. 2B is an alternate embodiment having a conductive mesh as the support material;

FIG. 3 is an alternate embodiment using conductive fibers with non-conductive support material made conductive with a conductive backing;

FIG. 4 is an alternate embodiment using boucle-type novelty yarn with a conductive core fiber;

FIG. 4A is an alternate embodiment using eyelash-type novelty yarn with conductive and non-conductive core fibers;

FIG. 5 is an alternate embodiment having novelty yarns woven into fabric;

FIG. 6 is an alternate embodiment with novelty yarns knitted together;

FIG. 7 shows a craft kit for a tufted lamp controller; and

FIG. 8 shows a craft kit for a tufted patch controller.

### DETAILED DESCRIPTION OF THE PREFERRED EMBODIMENT

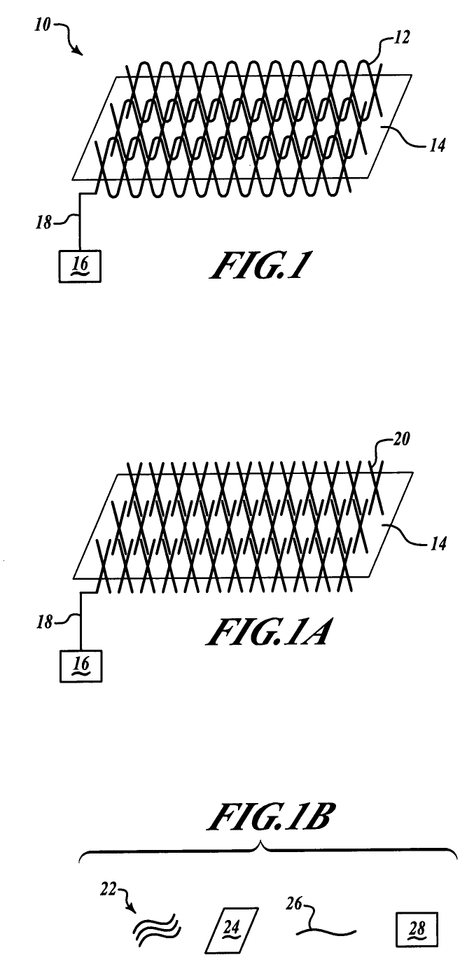

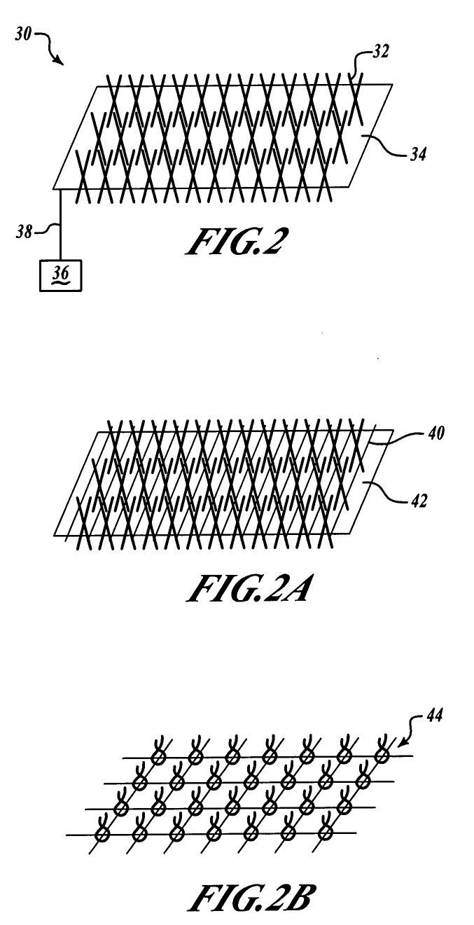

FIG. 1 illustrates the invention of a tufted controller 10 where conductive fibers or yarns 12 (at least one, but usually several) are used to create a contact sensor for controlling an electric or electronic device (not shown). In this embodiment, the continuous, conductive fibers 12 (yarn, thread, string, cordage, or the like) are integrated into a textile, such textile comprising the yarns themselves and/or an additional support material 14. The optional support material 14 may be woven or non-woven and may be made conductive or non-conductive, and the yarns 12 may be linked to the support material 14 by linking means—any conventional or new way such as by adhesion, embroidery, tufting, weaving, sewing, or knitting. In FIG. 1, and for illustrative purposes only, the yarns 12 have been linked by lofting or looping them through the flexible, non-conductive, support material 14. To practice the invention, it is not necessary that the yarns extend from both sides of the support material, and in fact, the yarns could be adhered to one side of the support material—for instance, by gluing. In this embodiment, the electrical interconnection, which allows for the large contact sensing area, is made by the lofted fibers 12 themselves, which are generally continuous and/or in close physical proximity to each other. Obviously, more or fewer fibers can be used to make the contact area larger or smaller or of a specific shape. The fibers in turn are directly connected to the capacitive sensing circuit 16 through an electrical connection element, e.g., wire, conductive tape, conductive fibers or conductive adhesive 18. Indeed, the electrical connection element 18 could be any metal element—such as a staple or grommet—or any other conductive element—with two opposing ends. Upon assembly, one end of the electrical connection element is connected to the conductive fibers—either directly or through a support material—and the opposing end of the electrical connection element is connected to the capacitive sensing circuit. The capacitive sensing circuit 16 is then linked as desired to the electric or electronic device to be controlled. Optionally, a pressure sensing circuit could be used instead of a capacitive one, providing for a different range of applications.

FIG. 1A is an alternate embodiment using conductive fibers 20 that have been cut rather than remaining looped. Cutting the lofted fibers provides a different look and feel to the textile from that in the FIG. 1 embodiment. In this configuration, the electrical interconnection between the lofted, cut yarns is still created by the close physical proximity of the conductive fibers 20.

FIG. 1B shows a craft kit and the elements thereof that a consumer may use to create and construct such a tufted controller as shown in the previous embodiments. This kit will include at least one continuous, conductive fiber 22, an electrical connection element 26 having two opposing ends, a sensing circuit 28, and instructions for assembling the tufted controller. Optionally, and to provide for a broader range of possible assemblies, the kit may also include a non-conductive support material 24. The conductive fiber 22 may be provided as a continuous fiber for linking by weaving into the support material 24 with instructions as to how to cut the fibers if desired, as well as directions for other linking methods of looping, lofting, sewing, knitting, weaving, tufting, embroidering, adhering, or otherwise linking the fiber to the support material 24. The instructions would include directions for connecting the electrical connection element at one end to the conductive fibers themselves and at the other end to the sensing circuit. Alternatively, the kit may include a conductive support material 24, in which case one end of the electrical connection element is to be linked directly to the conductive support material 24 and the opposing end is to be linked to the sensing circuit. The instructions may also include directions for completing the electrical circuit by connecting the sensing circuit 28 via the electrical connection element 26 thereby assembling the tufted controller. Finally, the instructions may also include directions for connecting a lamp, other light source, or other electric or electronic device to be controlled to the circuit.

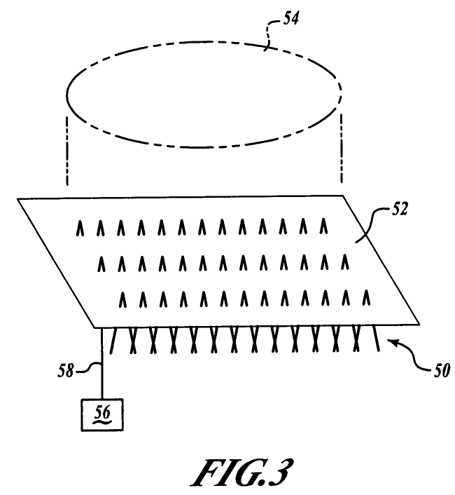

In FIG. 2, the continuous, conductive fibers 32 of the tufted controller 30 have been cut (i.e., are not looped), and although they may not be as physically close to each other (to allow for different materials and configurations), they still interconnect electrically through a conductive, flexible support material 34 and may be linked as in the previous embodiments. The support material may be woven, or non-woven, and may be conductive itself or made conductive by any new or conventional method such as a coating of conductive ink. Alternatively, the support material 34 may be made conductive by incorporating integrated conductive fibers in any direction. In this embodiment, the sensing circuit 36 is connected by an electrical connection element 38 (which connects at one end to the conductive support material itself, not to the conductive fibers as in FIG. 1, and at the other end to the capacitive sensing circuit 36) to complete the electrical circuit as in the above embodiments. The sensing circuit 36 is then linked as desired to the electric or electronic device to be controlled.

In FIG. 2A, the conductivity of the support material 42 is provided by interwoven conductive fibers 40 that run in only one direction (a common situation). The electrical connection element still connects between the support material and the sensing circuit as above. In FIG. 2B, the conductive support material may be a mesh or grid 44, and the fibers may be linked by a method similar to rug hooking. A kit can be provided with the appropriate elements and instructions to build this type of tufted, touch controller. Such a kit would have elements similar to those in FIG. 1B, with the difference that the support material 24 would be a conductive mesh, and appropriate instructions would be included.

The alternate embodiment of FIG. 3 allows that the support material may include a non-conductive base material 52 (providing for a different range of options) made conductive by the application of a conductive backing material 54 such as conductive tape, ink, or fabric. In this embodiment, the electrical interconnection among the lofted, conductive fibers 50 is made by the conductive backing 54. Then the sensing circuit 56 is connected as in the previous embodiments to one end of an electrical connection element 58, the other end being linked to the base material 52 in the area of the conductive backing.

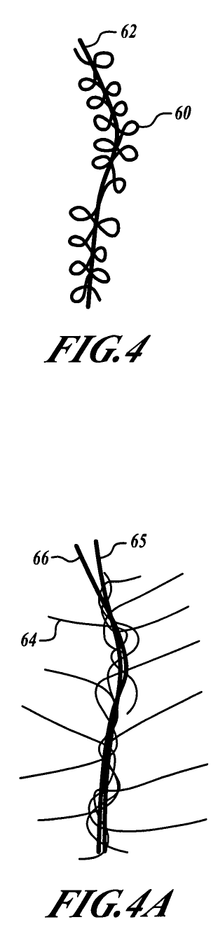

FIGS. 4 and 4A illustrate alternate embodiments of novelty yarn tufted controllers. In these embodiments, tufted controllers use conductive novelty yarns (at least one), with boucle-type, eyelash-type, mohair-type, slub, furry, or other conductive elements created lofted from a core element. Such a conductive novelty yarn (boucle- and eyelash types are used in these figures as representative of the group of novelty yarns) can then be used as the sensor itself (sensor yarn), without any support material as in the previous embodiments. The construction of these yarns may combine a lofted, textured, conductive fiber, which becomes the sensor with a conductive core fiber, which provides electrical continuity along the length of the yarn and interconnection between lofted yarns. Conversely, these yarns may rely on twisting of the lofted and/or cut yarns in the body to provide electrical interconnection and continuity along the length of the yarn. (In this case, the core yarn may be non-conductive, or even not present at all.) FIG. 4 shows a conductive boucle-type yarn 60 with conductive core fiber 62. In this embodiment, the circuit may be completed by having the conductive core fiber 62 or the conductive boucle-type fibers themselves connected to one end of an electrical connection element and the opposing end connected to a sensing circuit. FIG. 4A shows an eyelash-type yarn 64 with a conductive core fiber 65 and an optional, non-conductive, core fiber 66 for strength. In this embodiment, the circuit may be completed by having the conductive core fiber 65 or the conductive eyelash-type yarns themselves connected to one end of the electrical connection element and the opposing end connected to the sensing circuit.

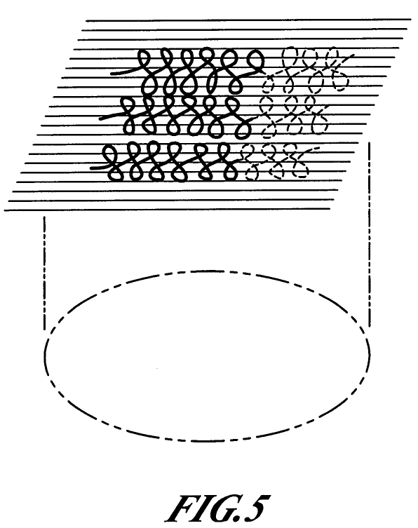

FIG. 5 illustrates how the novelty or sensor yarn may be knitted, woven, or otherwise integrated into a textile structure to form a sensor. In this figure, a boucle-type yarn is shown on the top side of the fabric and also on the bottom side. The yarn may then be cut to define the size and shape of the sensor. An optional conductive support or backing material as in the previous figures may be used to electrically connect the conductive novelty yarns. The controller would then be constructed with a sensing circuit connected via an electrical connection element as already explained. FIG. 6 shows how such novelty yarns (again a boucle-type is used for illustration) may be provided in a knitted construction with optional conductive backing material 68. In this embodiment, the novelty yarns are conductive, and the core fibers may be conductive, non-conductive, or a mixture of both. The optional backing material 68 may be made conductive with e.g., conductive tape, ink, fabric, or adhesive, and will be linked to the novelty yarns. Again, the controller would then be constructed with a sensing circuit connected via an electrical connection element.

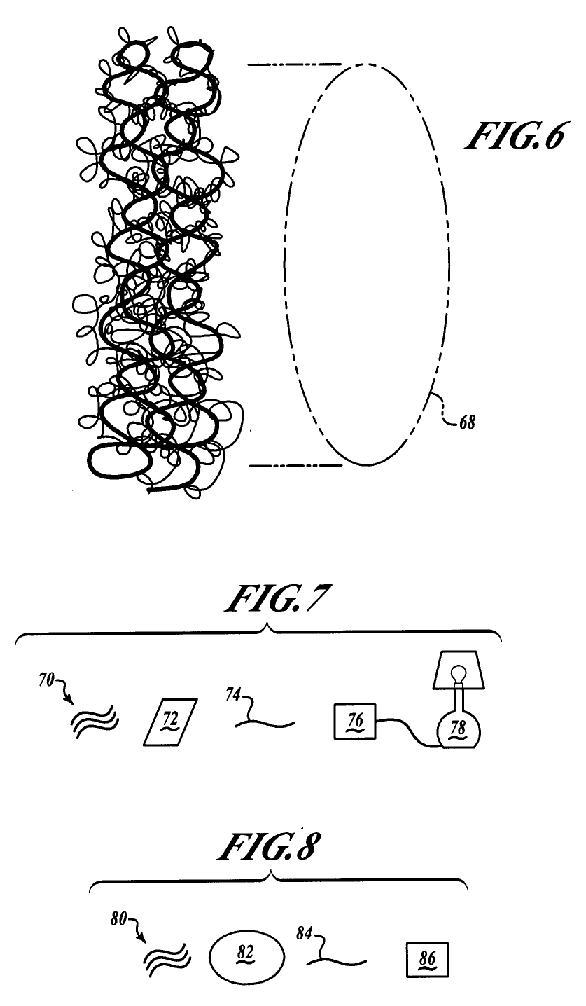

FIG. 7 shows a craft kit for a tufted lamp controller—a popular craft kit. The kit may contain: a conductive element 70 which in the figure is a group of conductive yarns, but may also be a tassel or other desirable structural element; a support material 72 (to be linked thereto) which may be conductive or non-conductive, but will typically be non-conductive for simplicity of instruction; an electrical connection element 74 having opposing ends, which may be e.g., a wire, yarn, or tape; and a sensing circuit 76. The instructions would include directions for assembling the tufted lamp controller by linking the conductive element to the conductive support material or conductive fibers and connecting the ends of the electrical connection element as necessary and as previously described and then linking the sensing circuit to a lamp 78 or other light source.

FIG. 8 shows a craft kit for a tufted patch controller—also a popular craft kit. The kit may contain: a conductive element 80 which in the figure is a group of conductive yarns, but may also be any other desirable structural element; a support material 82 (to be linked thereto) which may be conductive or non-conductive; an electrical connection element 84 having opposing ends; and an output patch 86. The patch may be worn on the outside of a garment—such as jacket or pants—and may contain various LEDs controlled by the tufted controller. The sensing circuit (not shown) may be made a part of the patch 86 (hidden, if desired, by an embroidered cover or the like), or may be located separately from the patch and electrically linked thereto as necessary. The instructions would include directions for assembling the tufted patch controller by linking the conductive element to the support material and connecting the ends of the electrical connection element as necessary and as previously described and linking the sensing circuit to the patch 86.

What is claimed is:

1. A tufted controller comprising at least one continuous, conductive fiber linked to a flexible non-conductive support material by linking means, and an electrical connection element having two opposing ends and being connected at one end to said conductive fiber and at the opposing end to a capacitive sensing circuit.

2. The tufted controller of claim 1 wherein said conductive fiber is chosen from the group comprising yarn, thread, string, and cordage.

3. The tufted controller of claim 1 wherein said linking means is chosen from the group comprising weaving, sewing, knitting, tufting, embroidering, and adhesion.

4. The tufted controller of claim 1 wherein said non-conductive, flexible support material is chosen from the group comprising woven and non-woven materials.

5. The tufted controller of claim 1 wherein said electrical connection element is chosen from the group comprising wire, staples, and grommets, conductive tape, conductive fibers, and conductive adhesive.

6. A tufted controller comprising at least one continuous, conductive fiber linked by linking means to a conductive flexible support material, and an electrical connection element having two opposing ends and being connected at one end to said support material and at the opposing end to a capacitive sensing circuit.

7. The tufted controller of claim 6 wherein said conductive fiber is chosen from the group comprising yarn, thread, string, and cordage.

8. The tufted controller of claim 6 wherein said linking means is chosen from the group comprising weaving, sewing, knitting, tufting, embroidering, and adhesion.

9. The tufted controller of claim 6 wherein said conductive, flexible support material is chosen from the group comprising woven and non-woven materials.

10. The tufted controller of claim 6 wherein said conductive support material is a conductive mesh, and said linking means comprise rug-hooking methods.

11. The tufted controller of claim 6 wherein said conductive support material comprises a non-conductive base material made conductive by the application of a conductive backing.

12. The tufted controller of claim 6 wherein said electrical connection element is chosen from the group comprising wire, staples, and grommets, conductive tape, conductive fibers, and conductive adhesive.

13. A kit for constructing a tufted controller comprising at least one continuous conductive fiber, an electrical connection having two opposing ends, a sensing circuit to be attached to said electrical connection, and instructions for assembling said tufted controller.

14. The kit of claim 13 wherein one end of said electrical connection is to be linked directly to said conductive fiber and the opposing end is to be linked to said sensing circuit.

15. The kit of claim 13 further comprising a conductive support material, and wherein one end of said electrical connection is to be linked directly to said support material and the opposing end is to be linked to said sensing circuit.

16. The kit of claim 13 wherein said instructions include directions for linking said fiber and assembling said tufted controller.

17. The kit of claim 13 wherein said directions for linking are chosen from the group comprising sewing, knitting, weaving, tufting, embroidering, and adhering.

18. A novelty yarn tufted controller comprising at least one conductive fiber lofted from a core element, an electrical connection having two opposing ends, one end being connected to said conductive fiber, and a sensing circuit connected to the opposing end of said electrical connection.

19. The novelty yarn tufted controller of claim 18 wherein said core element is non-conductive, and one end of said electrical connection is linked directly to said conductive fiber and the opposing end is connected to said sensing circuit.

20. The novelty yarn tufted controller of claim 18 wherein said core element is conductive, and one end of said electrical connection is linked directly to said core element and the opposing end is connected to said sensing circuit.

21. A craft kit for a tufted lamp controller comprising a conductive element, a support material linked thereto, an electrical connection element having opposing ends, with one end being connected to said conductive element, a sensing circuit connected to said opposing end of said electrical connection element, and a lamp linked to said sensing circuit.

22. A craft kit for a tufted patch controller comprising a conductive element, a support material linked thereto, an electrical connection element having opposing ends, one end being connected to said conductive element, a sensing circuit connected to said opposing end of said electrical connection element, and a patch linked to said sensing circuit.
